(19) United States
(12) Patent Application Publication
(10) Pub. No.: US 2008/0168719 A1
(43) Pub. Date: Jul. 17, 2008

(54) CONSTRUCTION HOLE SAFETY DEVICE

(76) Inventor: Phillip Borunda, Pomona, CA (US)

Correspondence Address: FULWIDER PATTON LLP, 6060 CENTER DRIVE, 10TH FLOOR, LOS ANGELES, CA, 90045, US

(21) Appl. No.: 12/037,765

(22) Filed: Feb. 26, 2008

Related U.S. Application Data
(63) Continuation-in-part of application No. 10/724,583, filed on Nov. 28, 2003.

(51) Int. Cl. E06B 5/10

(52) U.S. Cl. 52/20; 49/463

(57) ABSTRACT

The present invention is construction safety device designed for use on construction sites where man-made holes are present. The new safety device is constructed of high-impact resistant polyethylene, and is highly durable. The device is sized to fit snugly in construction holes, and can be walked on. It protects workers from hazards presented by holes, and keeps the holes clear of debris.

### CROSS-REFERENCES TO RELATED APPLICATIONS

This application is a Continuation-in-Part of U.S. application Ser. No. 10/724,583, filed Nov. 28, 2003 incorporated by reference in its entirety.

The present invention relates to the field of construction, especially construction of commercial and residential buildings. More specifically, this invention relates to safety devices for construction workers.

### BACKGROUND

Workers face a variety of hazards on a construction site. Many of these dangers are well known, and a number of safety devices developed to alleviate them. The construction hard hat is perhaps the best known of these.

A somewhat lesser described hazard is that offered by small holes in the ground. These are often man-made during the construction of drains, electrical wiring, lighting systems, and the like. While these are rarely large enough for an adult to fall into, they do provide a tripping hazard. They are of particular concern to workers on ladders or high stools or walkers. These can easily we caught in a small hole and tip over, resulting in injury to the workers aboard the ladder or equivalent.

### DESCRIPTION OF THE PRIOR ART

The present invention falls into the category of construction safety devices. There is a wealth of prior art in this area.

One relevant prior patent is U.S. Pat. No. 5,043,539, issued to inventor J. V. DeBartolo, Jr. on Aug. 27, 1991. His invention describes a knockout device for a wall.

Another relevant prior patent is U.S. Pat. No. 6,076,559, issued on Jun. 20, 2000 to inventor G. N. Castillo, describing a disposable protective cover for conventional plumbing fixtures during floor construction. However, this patent says nothing about being able to walk over it. In fact, it is shaped like a cup, and is designed to preserve a hole, not to cover it. As such, it is not a safety device.

D. D. Palmer is the inventor on yet another relevant prior patent, U.S. Pat. No. 5,507,501, which describes a sealing disc that is used in the pressure testing of a drain or vent in a plumbing system.

J. P. Lott et. al. are the inventors of U.S. Pat. No. 6,195,946, a patent that issued on Mar. 6, 2001. This patent describes concrete forms. In a similar patent, T. W. Meyers in U.S. Pat. No. 5,711,536 describes a seal for walls of poured concrete.

There is a need for a simple device that can protect construction workers from holes in the ground, particularly holes created by prior construction work. A protective device should be inexpensive yet durable, strong enough to bear the weight of a person walking thereon, and secure against forces (such as wind or running water) that may tend to move the device out of position.

### SUMMARY OF THE INVENTION

The present invention consists of a strong rubber or plastic unibody with cap and stem that is sized to fit precisely into the opening of a man-made construction hole, and remain securely therein until removed.

It is an object of the present invention to provide a safe environment for construction workers, especially during early and middle stages of construction.

It is another object of the present invention to prevent people from inadvertently stepping into holes created in the process of construction, and thereby possibly suffering injury.

It is yet another object of this invention that workers on movable scaffolding be protected from moving said scaffolding into a hole, possibly tipping over and causing injury to workers.

It is a further object of the present invention to create a device that is clearly visible to people nearby, and warns them of a danger posed by a hole potentially in their path.

It is yet another object of this invention that the device is capable of remaining in place and in service until removed by workers utilizing the hole for construction, and thereby removing the hazard.

It is yet another object of this invention that the device is capable of keeping a construction hole clean and free of debris that might otherwise accumulate within said hole, and later interfere with subsequent construction activities.

It is yet another object of this invention that the device is suitably made of materials that are best utilized for durability and long life in construction service.

It is yet another object of this invention that the device be lightweight and inexpensive, yet strong and durable.

The foregoing objects of the invention, and other objects and advantages will become apparent from the detailed description of the preferred embodiment below.

### BRIEF DESCRIPTION OF THE DRAWINGS

FIG. 1 displays from a side view a preferred embodiment of the current invention for use in circular (round) holes.

FIG. 2 shows the same preferred embodiment of the present invention from a top view.

FIG. 3 presents a side view of a second embodiment of the present invention in the manner of FIG. 1. This embodiment is rectangular, for rectangular cutouts.

FIG. 4 shows the second embodiment of FIG. 3 from a top view, in the manner of FIG. 2.

FIG. 5 displays a top view of the preferred embodiment after a warning label has been applied.

FIG. 6 shows the second embodiment of FIG. 3 from a top view, after a warning label has been applied.

FIG. 7 presents an application of the preferred embodiment to protect a drain site during construction of a residential bathroom.

FIG. 8 presents an application of the preferred embodiment to protect various drains and sites of floor lights during construction of a commercial building.

FIG. 9 presents an application of the preferred embodiment to protect a drain site during construction of a residential bathroom.

FIG. 10 displays yet another application of the preferred embodiment to protect coring holes for future installation of electrical panels in an industrial setting.

FIG. 11 displays still another application of the preferred embodiment on a residential kitchen site.

FIG. 12 displays yet another application of the preferred embodiment in an office or industrial bathroom site, again to protect drain holes.

FIG. 13 shows a couple of embodiments of the current invention from a side view, showing the top covers only.

In FIG. 14 is seen the current invention in place on a floor, either without (above) or with (below) sub-frame.

FIG. 15 illustrates a top view of another preferred embodiment of the present invention.

FIG. 16 is a bottom view of the embodiment of FIG. 15.

FIG. 17 is a side view of the embodiment of FIG. 15.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

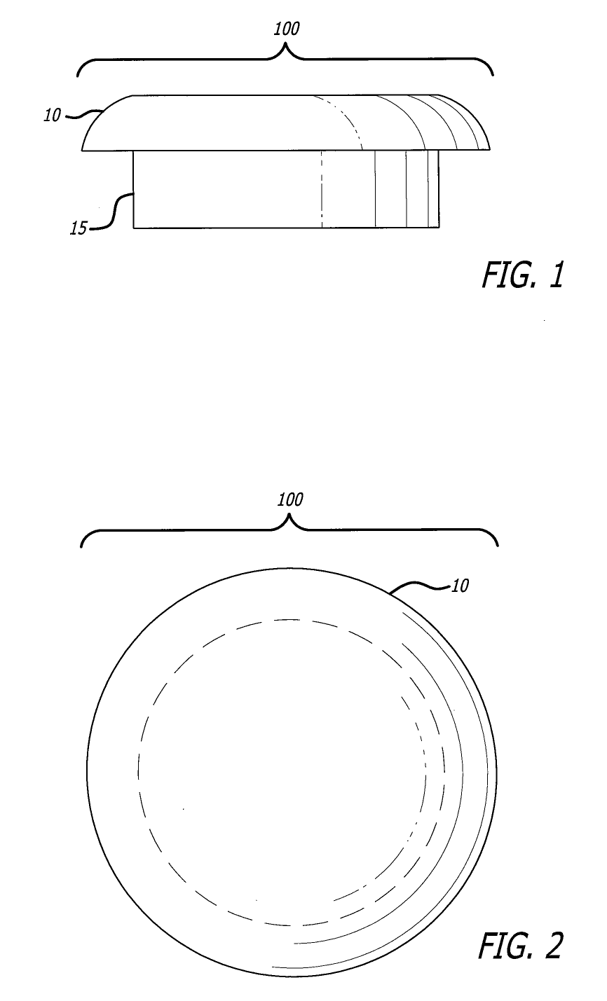

Referring to FIG. 1, a preferred embodiment 100 of the current invention is shown in side profile. It is shown with a top cap 10 and underlying stem 15. The stem is sized so as to fit closely in a construction drain hole, with different stem sizes corresponding to different drain sizes.

FIG. 2 shows the same preferred embodiment 100 of the current invention from a top plan view. Because the stem is sized to fit in the hole snugly, the top view completely obscures the hole.

In one preferred embodiment, the stem 15 will constitute a cylinder of 1 inch in diameter, appropriate for filing a 1-inch drain. The top cap 10 then will constitute a circle of about 1½ inches in diameter.

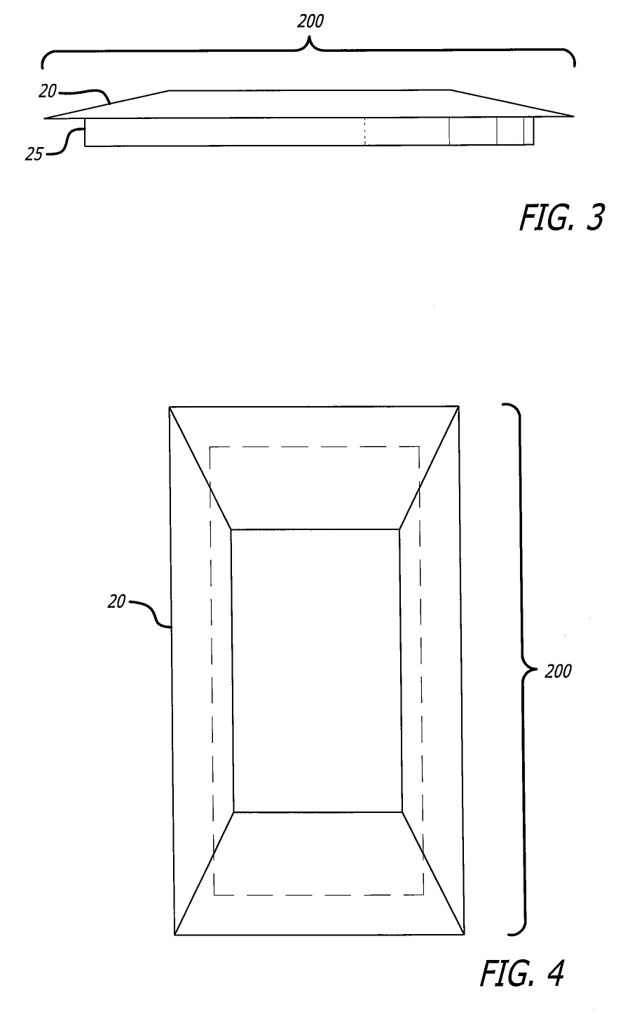

FIG. 3 is an alternate embodiment 200 of the current invention from a side plan view. The top cap 20 and the stem 25 are displayed.

FIG. 4 is a top plan view of the same embodiment 200 of the current invention as displayed in FIG. 3. From this view it can be seen that this embodiment is rectangular in shape. This is to correspond with rectangular cutout holes, as commonly used to install electrical switches and other components.

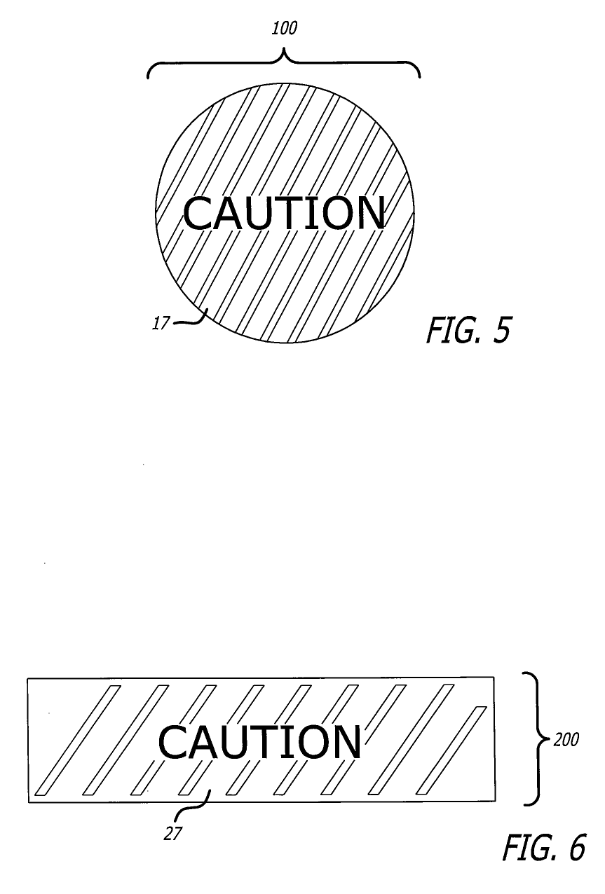

In FIG. 5, a view from the top is displayed of the preferred embodiment of the current invention in an example where a warning label 17 has been applied. The warning label consists of yellow lettering in black outline, with alternating black and yellow stripes.

The same view with a warning label 27 is displayed of the alternate rectangular configuration of the present invention in FIG. 6.

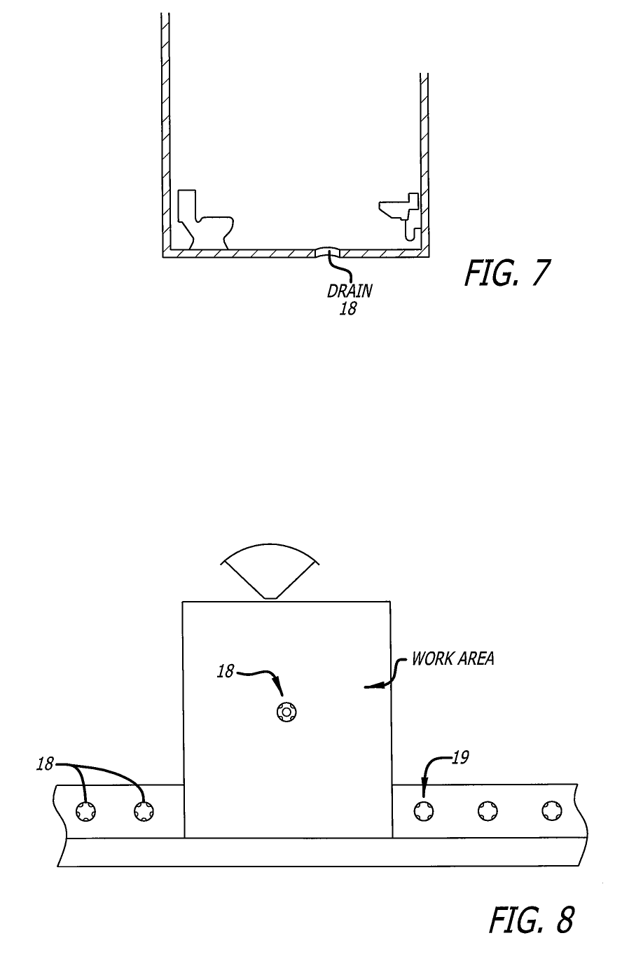

FIG. 7 shows an environment where the present invention could be employed. This is a residential bathroom under construction, with open drain hole 18. This could be protected with the preferred embodiment of FIG. 1 until the drain cover is installed.

FIG. 8 shows another environment where the present invention could be employed. This is a courtyard area under construction, with open drain holes 18 and holes 19 for floor lighting. These could be protected with the preferred embodiment of FIG. 1 until the drain covers and lights are installed.

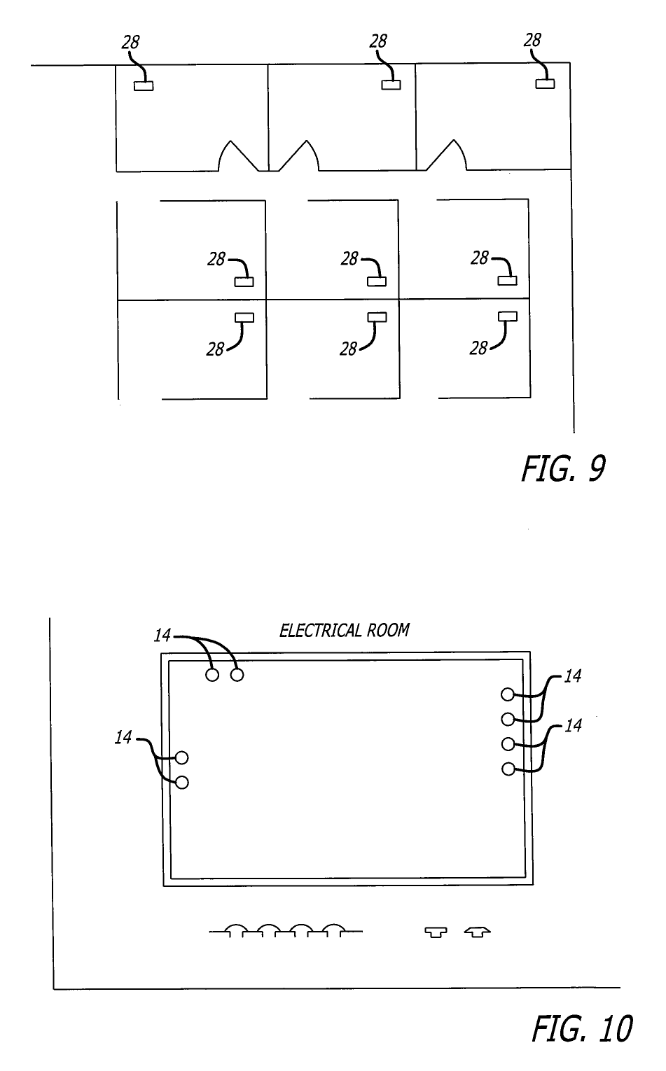

FIG. 9 displays yet another environment where the rectangular embodiment of the present invention could be employed. This is an office area under construction, with open holes 28 for floor installation of electrical wiring for office equipment such as desktop workstations, lighting, and the like.

FIG. 10 illustrates still another environment where the present invention could be employed. This is an electrical under construction, with open coring holes 14 for floor installation of heavy-duty electrical wiring. These holes could be protected with the preferred embodiment of FIG. 1 until the electrical wiring is installed.

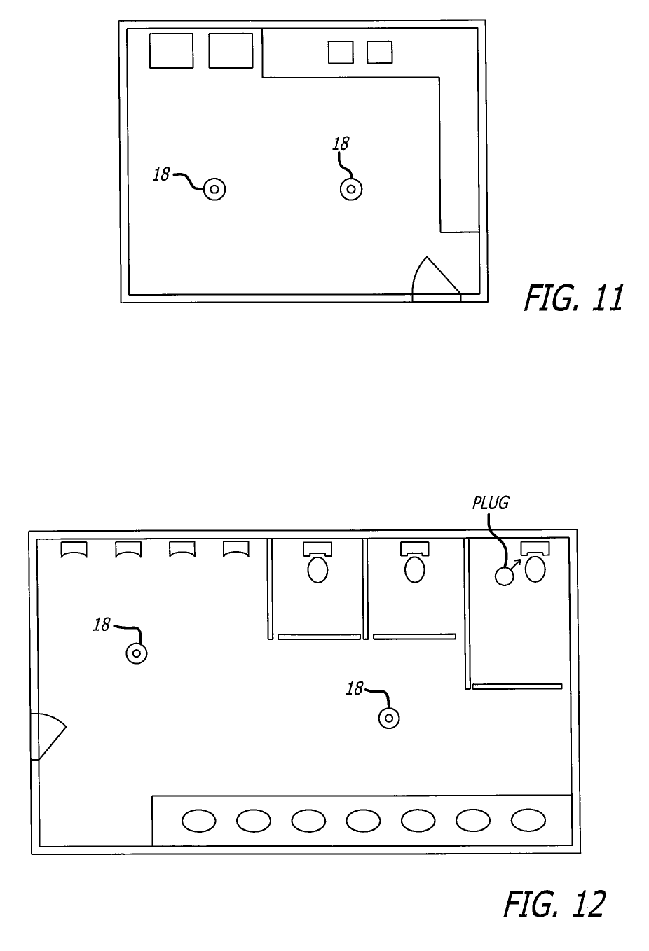

FIG. 11 depicts still another environment where the present invention could be employed to protect open drain holes 18 until covered in subsequent construction. Likewise,

FIG. 12 illustrates an industrial area with open drain holes 18, suitable for protection by installing the present invention.

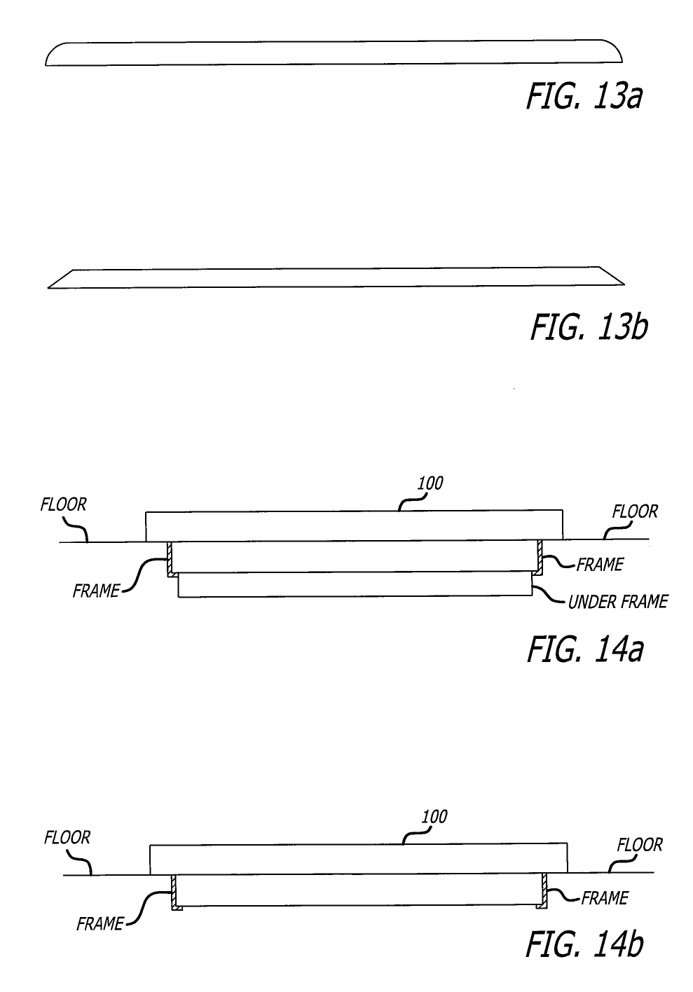

FIG. 13 illustrates selected styles of top caps that could be employed with the present invention. Different curves of the edges, and height of the cap are envisioned. However, in general the cap will be no more than ¼ inch in thickness. This is to avoid presenting a tripping hazard.

FIG. 14 depicts the present invention 100 in place in a hole in a floor. The invention is seen from a cutaway side view. FIG. 14a shows a floor with frame and underframe forming the two lower layers, with the cap of the present invention forming the top layer. FIG. 14b shows the same view, in a floor without underframe. In this case, the frame forms the lower layer, with the cap of the present invention forming the top layer.

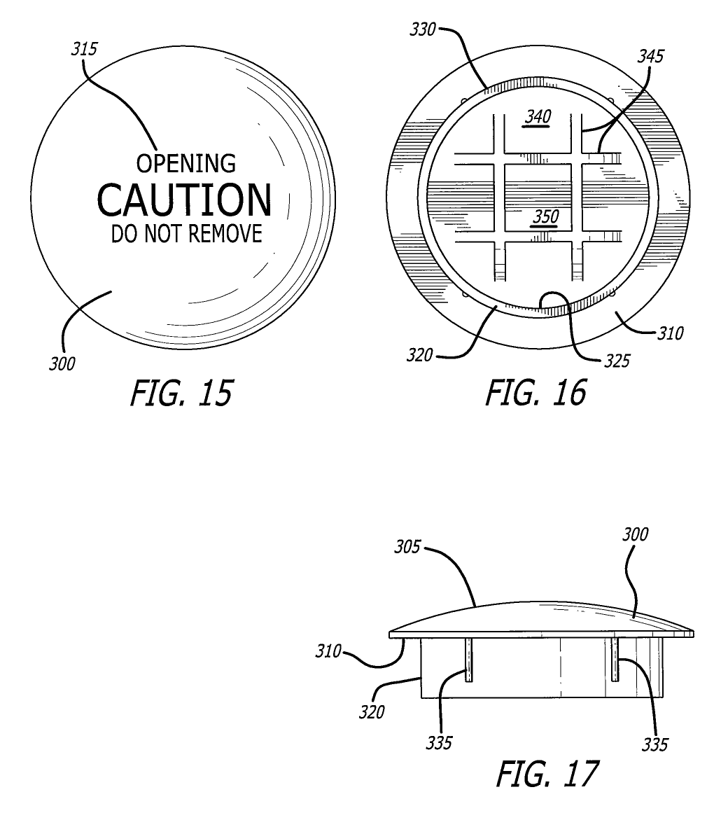

FIGS. 15-17 illustrate another embodiment of the present invention having a cover 300 formed with a solid, convex upper surface 305 and a generally smooth, flat lower surface 310. The upper surface 305 may include a hot stamped cautionary indicia 315 imprinted thereon, such as the words “CAUTION” and “DO NOT REMOVE.” The cover 300 is integrally formed with an annular stem 320 with an inner surface 325 and an outer surface 330. The outer surface 330 is preferably formed with longitudinally extending elongate ribs 335 spaced apart by regular angular intervals such as ninety degrees. The ribs 335 extend from the cover's flat lower surface 310 to a position beyond the midpoint of the stem 320, and more preferably about three quarters of the distance of the stem. The ribs 335 prevent jamming of the device in close-fit holes while providing a better fit for holes with higher tolerances. The ribs also help to strengthen the stem and provide additional stiffness. In a preferred embodiment the ribs 335 are trapezoidal in cross-section to further increase the stiffness. The ribs 335 can number anywhere from two to eight or more, but a preferred embodiment includes four equally spaced apart ribs. In a preferred embodiment, the lower surface of the cover 340 that lies inside the stem 320 is arched to reduce materials, but includes reinforcing members 345 to increase the loading capability of the device. The reinforcing members 345 can extend across the walls of the stem 320 in a grid pattern to provide resistance to collapse of the arch forming the cover 300. In a preferred embodiment, the hatch pattern is formed by two parallel members intersecting two transverse members to form a square 350 in the middle of the lower surface 340. The reinforcing members contribute to the present invention's sturdiness and resistance to compression in compliance with many federal and state regulations. The present invention in the three inch diameter and four inch diameter are capable of withstanding five thousand pounds of load without failure (i.e., suffering permanent deformation).

The present invention is made of sturdy materials, such as hard engineering polyethylene, to withstand the weight of heavy construction workers walking or standing on it. In a preferred embodiment, the invention is made of 1-propene, polymer with ethene percent by weight greater than 98. The device is preferably bright yellow to ensure high visibility in construction environments, where indicia is colored black to establish a high contrast and improve the cautionary function. The invention is designed to meet all OSHA requirements for safety.

The stem is sized, both in horizontal and vertical dimensions, to fit snugly in the construction holes. Such precise fitting is important to maintaining the structural integrity of the device, and to allow the device to remain stably within the hole. The device is positioned without screws or fasteners, but rather is gravitationally positioned and is easily removed.

It should be recognized that holes made for construction purposes are well defined in dimensions, and limited in variability and number of different sizes. Thus, it is feasible to produce the present invention in a limited number of sizes and dimensions, to conform to said limited sizes and dimensions of construction holes.

Installation of the present invention is very straightforward. It is simply a matter of selecting the appropriate size and shape of the embodiment that best fits the hole to be protected. The embodiment is then place in the hole with top cover facing up, and thus displaying the optional warning label. The device is left in place until removed by later construction workers, at the time the hole is to be utilized.

The device is designed to be reusable, and potentially recyclable if damaged during use.

1. A construction hole safety device comprising:
a top cap having top and bottom surfaces and an underlying body stem fixedly attached to the bottom surface of said cap and extending substantially perpendicularly from said bottom surface, said device made of sturdy, wear-resistant material, wherein said body stem can fit within a man-made hole, and withstand the weight of people and construction equipment traveling thereon.

2. The device of claim 1, wherein said device is one piece.

3. The device of claim 1, wherein the top cap and body stem are both substantially circular in configuration.

4. The device of claim 1, wherein said device is substantially rectangular in both top cap and body stem.

5. The device of claim 1, wherein said top cap is larger in diameter at all points than the body stem by at least ⅛ inch.

6. The device of claim 1, wherein said device is comprised of high-impact polyethylene.

7. The device of claim 1, wherein said device bears warning labels attached to the top cap such that such labels are clearly visible when the device is in use.

8. The device of claim 1 where the top surface of the top cap tapers downwardly from the center area of the cap towards the outside edge of said cap.

9. The device of claim 1, where the taper is in the form of a downward curve.

10. The device of claim 1, wherein said body stem comprises a hollow cylinder.

11. The device of claim 1, wherein the body stem is sized to fit snugly into a construction hole.

12. The device of claim 1, wherein said device is positioned within the construction hole by means of the body stem.

13. A removable, gravitationally positioned cover for extending over a hole to prevent injury, comprising:
an top wall defining a solid, convex, generally smooth upper surface and a lower surface including a substantially flat outer edge;
a hollow stem integrally formed with said top wall and depending downwardly therefrom, said stem including an inner surface and an outer surface;
a plurality of rib members extending longitudinally along said outer surface of said stem from said lower surface of said top wall to a position below a midpoint of said stem.

14. The cover of claim 13 further comprising reinforcing members on said lower surface of said top wall within said inner surface of said stem, said reinforcing members arranged in a grid pattern.

15. The cover of claim 13 wherein the upper surface of the top wall is yellow, and includes a cautionary indicia in black.

16. The cover of claim 15 wherein the cautionary indicia is hot stamped into the upper surface of the top wall.

17. The cover of claim 13 wherein the top wall and stem are constructed of 1-propene, polymer with ethene.

18. The cover of claim 13 where the rib members have a trapezoidal cross-section.

19. The cover of claim 13 where the cover is capable of sustaining a load of up to five thousand pounds without failing.
